(19) United States
(12) Patent Application Publication
(10) Pub. No.: US 2025/0093372 A1
(43) Pub. Date: Mar. 20, 2025

(54) EXTRACTION ANALYSIS SYSTEM

(71) Applicant: SHIMADZU CORPORATION, Kyoto (JP)

(72) Inventors: Mikoto TAKI, Kyoto (JP); Maki SAITO, Kyoto (JP)

(73) Assignee: SHIMADZU CORPORATION, Kyoto (JP)

(21) Appl. No.: 18/814,479

(22) Filed: Aug. 24, 2024

(30) Foreign Application Priority Data
Sep. 20, 2023 (JP) 2023-151922

(51) Int. Cl. G01N 35/00; G01N 35/04

(52) U.S. Cl. CPC G01N 35/00584; G01N 2035/00801; G01N 2035/0401

(57) ABSTRACT

An extraction analysis device includes a placement table for placing a rack holding a plurality of extraction containers, and an analysis channel for analyzing a component extracted from a sample, and is configured to set the plurality of extraction containers held in the rack placed on the placement table as extraction targets in a preset order, to execute an extraction operation for extracting components from a sample to a mobile phase that is a supercritical fluid in the extraction container set as the extraction target, and to execute analysis of the components by introducing the components extracted by the extraction operation into the analysis channel. A rack replacement device is configured to execute replacement of the rack on the placement table by performing movement of the rack from the placement table of the extraction analysis device and placement of the rack on the placement table. The extraction analysis device is configured to bring the rack into a movable state in which the rack can be moved from the placement table during the analysis of a component extracted from a sample by the extraction operation in the extraction container set as a last extraction target among the plurality of extraction containers held in the rack. The rack replacement device is configured to execute replacement of the rack on the placement table during the analysis of the component extracted by the extraction operation in the extraction container set as the last extraction target.

### BACKGROUND OF THE INVENTION

### 1. Field of the Invention

The present invention relates to an extraction analysis system that extracts a target component from a sample using a supercritical fluid and analyzes the extracted component.

### 2. Description of the Related Art

There is a known component extraction device that extracts a component from a sample using a supercritical fluid. In such a component extraction device, an extraction container that contains a sample is held by a rack, and the rack is placed on a placement table provided in the component extraction device. The rack can hold a plurality of extraction containers. A sample in an extraction container before a component is extracted is generally stored in a cooled state in order to suppress alteration and volatilization. On the other hand, before extraction of the component is performed, the extraction container is heated in order to increase the extraction efficiency of the component, and the temperature regulation of the extraction container is performed.

There is a proposed component extraction device in which a heater or a temperature sensor corresponding to each extraction container held in a rack is provided on a placement table in order to individually perform temperature regulation of the extraction containers held in the rack placed on the placement table (see, for example, JP 2017-146127 A). According to the proposed component extraction device, by performing temperature regulation immediately before extraction of a component is performed in each extraction container held in the rack, it is possible unify the temperature regulation time of samples contained in the extraction containers.

In a case of performing online up to analysis of a component extracted from a sample in the extraction container, in order to perform the process from extraction to analysis of the component for all the samples contained in the extraction containers on the rack, it is necessary to sequentially repeat the processes of temperature regulation, extraction, and analysis for each of the extraction containers. For example, in a case where a rack holds four extraction containers and it requires 15 minutes for temperature regulation, 10 minutes for extraction, and 5 minutes for analysis, it requires 30 minutes for one extraction container, and it takes at least 2 hours to complete the analysis on the samples in all the extraction containers on the rack.

Note that by performing temperature regulation of the next extraction container during execution of extraction of a component in a certain extraction container or analysis of the extracted component, it is possible to shorten the time required to complete analysis of the samples in all the extraction containers held in the rack.

### SUMMARY OF THE INVENTION

Since the number of extraction containers that can be held in one rack is limited, if there are a large number of samples that are analysis targets, it is necessary to hold a large number of extraction containers in a plurality of racks and sequentially replace the racks on the placement platform of the component extraction device. Replacement of the racks on the placement table can be automatically executed by a rack replacement device. In the conventional system including the rack replacement device, when the analysis of the sample of the extraction container held in the rack on the placement table is completed, a management device managing the system notifies the rack replacement device that all the processing of the extraction container of the rack on the placement table is completed, and the rack replacement device replaces the racks on the placement table. Therefore, at the timing involving replacement of the racks, a plurality of processing cannot be executed in an overlapping manner, and there is a limitation in shortening the time required to complete a series of processing of a large number of samples that require the use of a plurality of racks.

The present invention has been made in view of the above problems, and an object of the present invention is to shorten the time required for analysis of samples in a plurality of extraction containers held in a plurality of racks by overlapping a plurality of processing at the timing involving replacement of the racks.

An extraction analysis system according to the present invention is an extraction analysis system including an extraction analysis device and a rack replacement device, in which the extraction analysis device includes a placement table for placing a rack holding a plurality of extraction containers and an analysis channel for analyzing a component extracted from a sample, and the extraction analysis device is configured to set the plurality of extraction containers held in the rack placed on the placement table as extraction targets in a preset order, to execute an extraction operation for extracting components from a sample to a mobile phase being a supercritical fluid in the extraction container set as the extraction target, and to execute analysis of the components by introducing the components extracted by the extraction operation into the analysis channel, the rack replacement device is configured to execute replacement of the rack on the placement table by performing movement of the rack from the placement table of the extraction analysis device and placement of the rack on the placement table, the extraction analysis device is configured to bring the rack into a movable state in which the rack can be moved from the placement table during the analysis of components extracted from a sample by the extraction operation in the extraction container set as a last extraction target among the plurality of extraction containers held in the rack, and the rack replacement device is configured to execute replacement of the rack on the placement table during the analysis of the components extracted by the extraction operation in the extraction container set as the last extraction target.

According to the extraction analysis system according to the present invention, the extraction analysis device brings the rack into a movable state in which the rack can be moved from the placement table during the analysis of components extracted from a sample by the extraction operation in the extraction container set as a last extraction target among the plurality of extraction containers held in the rack, and the rack replacement device executes replacement of the rack on the placement table during the analysis of the component extracted by the extraction operation in the extraction container set as the last extraction target, and therefore, rack replacement and processing after the rack replacement can be overlapped at a timing involving replacement of the racks, and the time required for the analysis of the samples in the plurality of extraction containers held in the plurality of racks is shortened.

### BRIEF DESCRIPTION OF THE DRAWINGS

FIG. 1 is a schematic configuration diagram illustrating one example of an extraction analysis system;

FIG. 2 is a diagram illustrating a channel configuration at the time of extraction of a component from a sample in the example;

FIG. 3 is a view illustrating a channel configuration when a component extracted in an extraction container is introduced into an analysis channel in the example;

FIG. 4 is a view illustrating a channel configuration in an analysis mode in the example; and

FIG. 5 is a timing chart showing an example of execution timing of a series of processing of samples in a plurality of extraction containers held in a plurality of racks in the example.

### DETAILED DESCRIPTION OF THE INVENTION

Hereinafter, an embodiment of an extraction analysis system according to the present invention will be described with reference to the drawings.

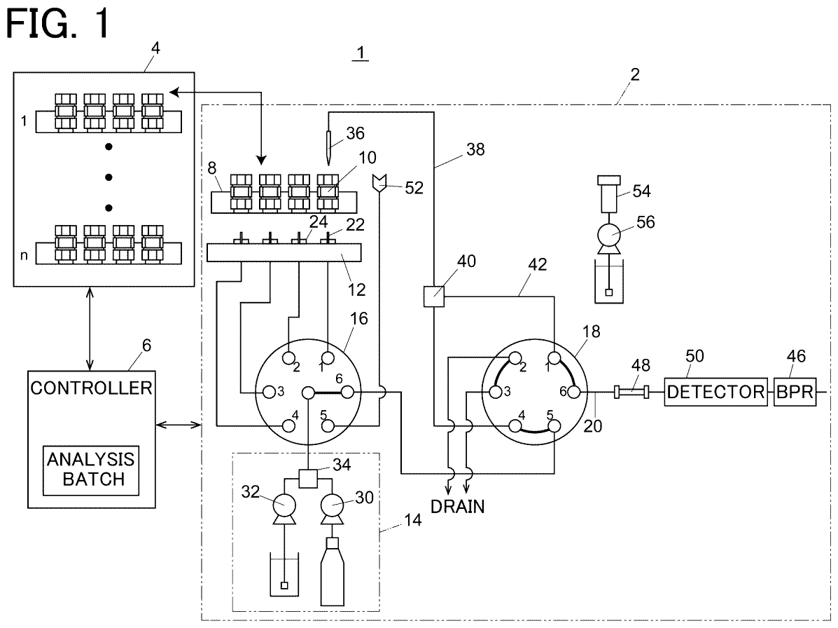

FIG. 1 illustrates one example of the extraction analysis system.

An extraction analysis system 1 of this example includes an extraction analysis device 2, a rack replacement device 4, and a controller 6.

The extraction analysis device 2 mainly includes a placement table 12, a mobile phase supply unit 14, an extraction valve 16, a vent valve 18, an analysis channel 20, a needle 36, and a back pressure control valve (hereinafter, BPR) 46.

A rack 8 is placed on the placement table 12. The rack 8 can hold a plurality of (4 in this example) extraction containers 10. The extraction container 10 has an internal space for containing a sample and extracting a component from the sample, and includes ports leading to the internal space on each of an upper surface and a lower surface. The placement table 12 includes a connection pipe 22 and a heater 24 at positions corresponding to the respective extraction containers 10 held on the rack 8 to be placed. The connection pipe 22 is a thin pipe that is inserted into the port on the lower surface of each of the extraction containers 10 held by the rack 8 when the rack 8 is placed at a predetermined position on the placement table 12 and is fluidly connected to the internal space of the extraction container 10. The heater 24 is for individually heating each of the extraction containers 10 by coming into contact with the lower surface of each of the extraction containers 10 held by the rack 8 when the rack 8 is placed at a predetermined position on the placement table 12.

The mobile phase supply unit 14 supplies liquid carbon dioxide and a modifier by pumps 30 and 32. The liquid carbon dioxide and the modifier are mixed in a mixer 34. The mobile phase supply unit 14 is fluidly connected to a common port at the center of an extraction valve 18 described later.

The extraction valve 16 includes one common port provided at the center and first to sixth selection ports provided around the common port, and is configured to cause the common port to be in fluid communication with any one of the first to sixth selection ports. As described above, the mobile phase supply unit 14 is fluidly connected to the common port of the extraction valve 16. A channel leading to the connection pipe 22 of the placement table 12 is fluidly connected to each of the first to fourth selection ports of the extraction valve 16, and the common port of the extraction valve 16 is fluidly connected to the first to fourth selection ports, whereby the mobile phase from the mobile phase supply unit 14 can be supplied to a desired extraction container 10 of the rack 8 placed on the placement table 12. A home port 52 serving as a home position of a needle 36 described later is fluidly connected to the fifth port of the extraction valve 16. The sixth port of the extraction valve 16 is fluidly connected to the fifth port of the vent valve 18 described later.

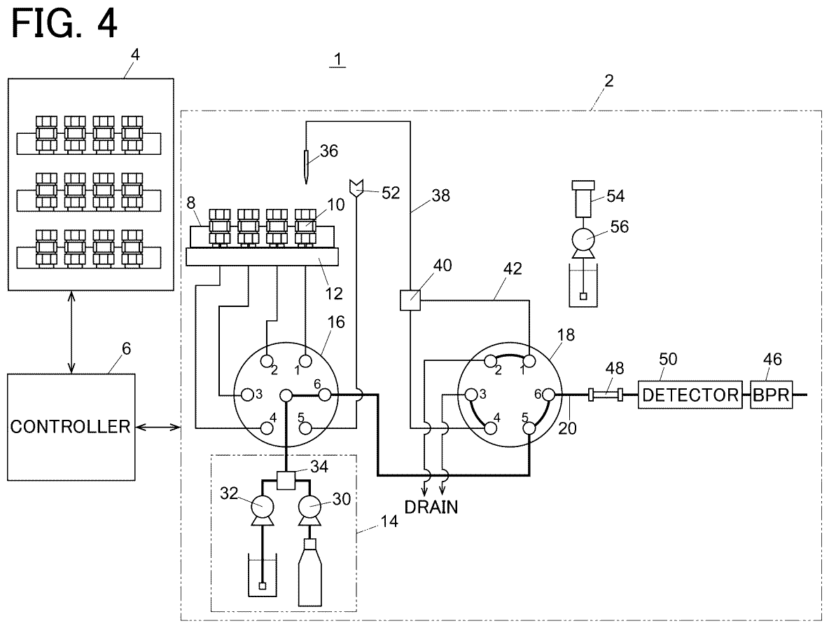

The vent valve 18 is a two-position valve having the first to sixth ports provided on the same circumference and causing ports adjacent to each other to fluidly communicate with each other. That is, the vent valve 18 can be brought into in any of a first state (state of FIG. 1) in which the first and sixth ports, the second and third ports, and the fourth and fifth ports are in fluid communication and a second state (state of FIG. 4) in which the first and second ports, the third and fourth ports, and the fifth and sixth ports are in fluid communication.

As described above, the fifth port of the vent valve 18 is fluidly connected to the sixth port of the extraction valve 16, and an extraction channel 38 leading to the needle 36 and the analysis channel 20 are fluidly connected to the fourth port adjacent to the sixth port and the sixth port, respectively. A branch channel 42 branching from the extraction channel 38 via a T-shaped pipe 40 is fluidly connected to the first port of the vent valve 18, and the second and third ports each lead to a drain.

The analysis channel 20 includes a separation column 48 and a detector 50. The BPR46 is provided on the analysis channel 20, and is for controlling the pressure in the system between the mobile phase supply unit 14 and the analysis channel 20 so that the mobile phase supplied from the mobile phase supply unit 14 becomes a supercritical fluid. In this example, the BPR46 is provided at a subsequent stage of the detector 50, but the position of the BPR46 on the analysis channel 20 can be changed.

The needle 36 can move in a horizontal direction and a vertical direction by a movement mechanism not illustrated. The needle 36 is for fluidly connecting the extraction channel 38 to the extraction container 10 by being inserted from the tip into a port on the upper surface of the extraction container 10 held by the rack 8 placed on the placement table 12.

The extraction analysis device 2 further includes a cleaning port 54. The cleaning port 54 is supplied with a cleaning liquid by a pump 56, and can clean the needle 36 as necessary.

Although not illustrated in detail in the drawing, the rack replacement device 4 is a device that includes a storage that contains the plurality of racks 8 and an arm that moves between the storage and the placement table 12 of the extraction analysis device 2, and performs placement of the racks 8 onto the placement table 12 of the extraction analysis device 2 and movement of the racks 8 from the placement table 12, thereby executing replacement of the racks 8 on the placement table 12. The rack 8 stored in the storage is given, as rack information, a rack number indicating a position stored in the storage.

The controller 6 is for performing operation management of the extraction analysis system 1 by giving an operation instruction to the extraction analysis device 2 and the rack replacement device 4 in accordance with a preset operation sequence. In this example, the operation sequence is set by an analysis batch in which operations and conditions to be executed by the extraction analysis device 2 and the rack replacement device 4 are described in each batch row. The controller 6 sequentially reads batch rows described in the analysis batch, and gives an operation instruction to the extraction analysis device 2 and/or the rack replacement device 4 in accordance with the operation condition described in each batch row, thereby operating the extraction analysis device 2 and/or the rack replacement device 4. For example, at the timing of performing replacement of the rack 8 on the placement table 12 of the extraction analysis device 2, the controller 6 reads the rack number described in the corresponding batch row of the analysis batch, and gives the rack replacement device 4 information as to which position in the storage the rack 8 with which the rack 8 on the placement table 12 is replaced is stored. The controller 6 can be implemented by a dedicated computer or a general-purpose personal computer.

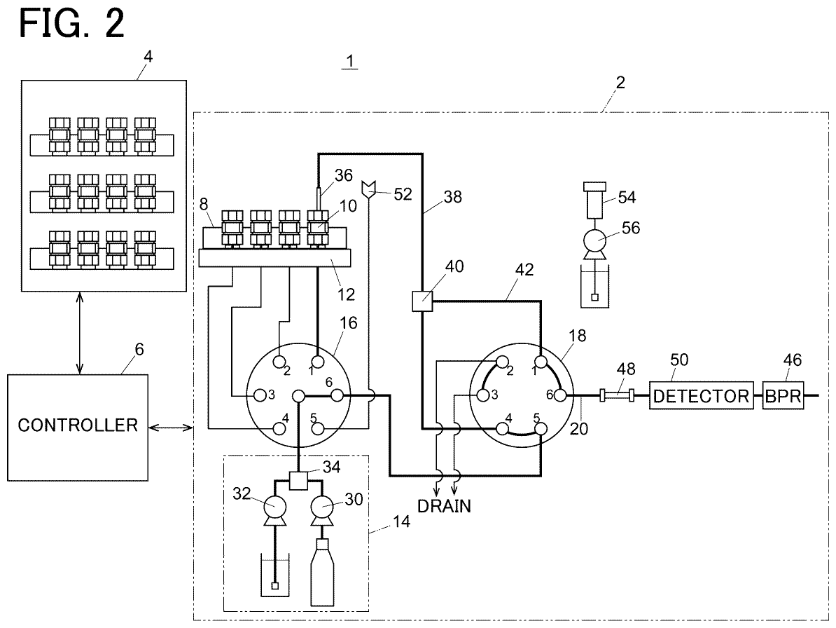

Here, each processing in the extraction analysis device 2 will be described with reference to FIGS. 2 to 4.

First, temperature regulation of heating the extraction container 10 that is an extraction target containing the sample of an analysis target to a predetermined temperature is performed. The temperature regulation of the extraction container 10 is executed immediately before extraction processing of a component described later is executed. Therefore, at this stage, the temperature regulation of the extraction container 10 that is not an extraction target is not performed.

After the temperature regulation of the extraction container 10 described above is completed, as illustrated in FIG. 2, the needle 36 is inserted into the extraction container 10 of the extraction target, the common port of the extraction valve 16 is fluidly communicated with the sixth port, the vent valve 18 is brought into the first state, the fourth and fifth ports are fluidly communicated with each other, the mobile phase from the mobile phase supply unit 14 is supplied to the extraction container 10 of the extraction target through the extraction channel 38, and the extraction container 10 of the extraction target is filled with the mobile phase. At this time, the inside of the system between the mobile phase supply unit 14 and the extraction container 10 is controlled to a predetermined pressure by the BPR46, and the extraction container 10 is filled with the mobile phase that has become a supercritical fluid. This state is maintained until a predetermined time elapses after the extraction container 10 of the extraction target is filled with the mobile phase, and the component of the sample is extracted into the mobile phase in the extraction container 10.

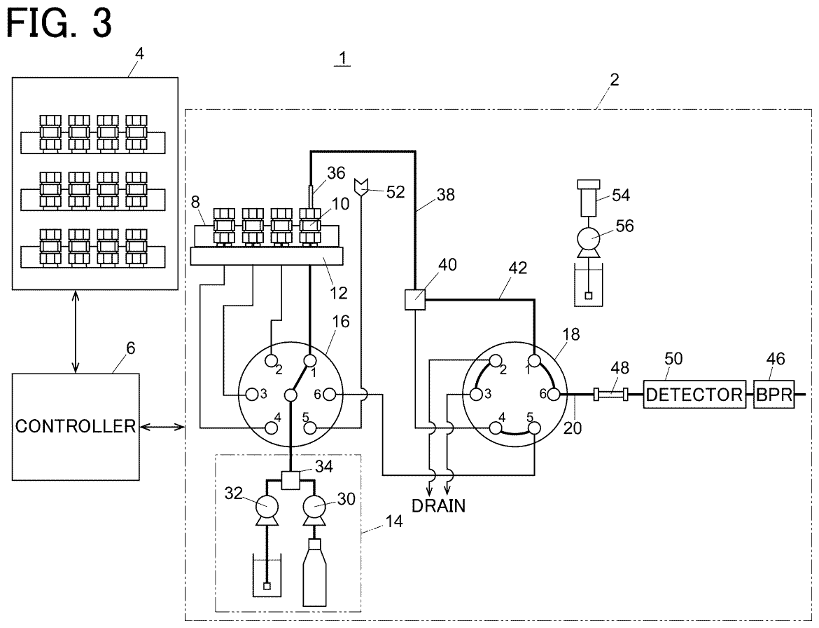

After the extraction processing is ended, as illustrated in FIG. 3, the extraction valve 16 is switched so as to fluidly connect the mobile phase supply unit 14 to the extraction container 10 of the extraction target, and the mobile phase is fed from the mobile phase supply unit 14. The mobile phase is supplied from below the extraction container 10 of the extraction target, whereby the mobile phase containing the component extracted from the sample in the extraction container 10 is introduced into the analysis channel 20 via the extraction channel 38, the T-shaped pipe 40, the branch channel 42, and the vent valve 18.

After the component is introduced into the analysis channel 20, as illustrated in FIG. 4, the extraction valve 16 is switched so that the common port and the sixth port are in fluid communication with each other, and the vent valve 18 is switched to the second state so that the fifth and sixth ports are in fluid communication with each other, so that the mobile phase supply unit 14 is fluidly connected to the analysis channel 20 without not via the extraction channel 38 and the branch channel 42. This state is called an analysis mode. In this analysis mode, the component introduced into the analysis channel 20 by supplying the mobile phase from the mobile phase supply unit 14 to the analysis channel 20 is guided to the separation column and separated, and then detected by the detector 50.

In the extraction analysis device 2, the extraction containers 10 on the rack 8 placed on the placement table 12 are made extraction targets in a preset order, and the processing from temperature regulation to analysis described above are sequentially executed on the extraction containers 10 that is the extraction target. The extraction analysis device 2 is configured to output a replaceable signal to the controller 6 when a component extracted from the sample in the extraction container 10 that has become an extraction target last among the extraction containers 10 of the rack 8 placed on the placement table 12 is introduced into the analysis channel 20 and transitions to the analysis mode illustrated in FIG. 4.

In the analysis mode of FIG. 4, since both the extraction container 10 of the extraction target and the needle 36 are separated from the mobile phase supply unit 14 and the analysis channel 20, the needle 36 can be pulled out from the extraction container 10, and after the needle 36 is pulled out from the extraction container 10, the rack 8 is brought into a movable state where the rack 8 can be moved from the placement table 12. At this time, analysis of the component extracted by the extraction container 10 of the last extraction target is executed, but the rack 8 on the placement table 12 is replaceable. Upon receiving the replaceable signal from the extraction analysis device 2, the controller 6 reads the next batch row of the analysis batch, and gives the rack replacement device 4, together with a rack replacement signal, information regarding a new rack 8 to be placed on the placement table 12 next. Upon receiving the rack replacement signal from the controller 6, the rack replacement device 4 replaces the rack 8 on the placement table 12 with the new rack 8 in accordance with the information received together with the rack replacement signal.

In general batch processing, when processing of a batch row currently in execution is completed, a next batch row is read and processing is executed. That is, in a case where the general batch processing is applied to this extraction analysis system, when the controller 6 receives, from the extraction analysis device 2, a completion signal indicating that the analysis of the component extracted from the sample in the extraction container 10 is completed in the extraction analysis device 2, the controller 6 reads the next batch row of the analysis batch. Therefore, even if the component under analysis is extracted from the extraction container 10 of the last extraction target of the rack 8 on the placement table 12, replacement of the rack 8 on the placement table 12 is not performed before the analysis is completed. On the other hand, in this example, since the controller 6 reads the next batch row upon receiving the replaceable signal from the extraction analysis device 2, the racks 8 can be replaced while the analysis of the component extracted from the extraction container 10 of the last extraction target is in execution.

Furthermore, when the rack 8 on the placement table 12 is replaced with a new one, the controller 6 receives a replacement completion signal from the rack replacement device 4, reads the next batch row, and can start temperature regulation of the extraction container 10 of the next extraction target to the extraction analysis device 2. Thus, in this example, by executing replacement of the rack 8 on the placement table 12 and starting the temperature regulation of the extraction container 10 of the next extraction target while executing analysis of the component extracted in the extraction container 10 of the previous extraction target, it is possible to shorten the time required for a series of processing of the samples in the plurality of extraction containers 10 held in the plurality of racks 8.

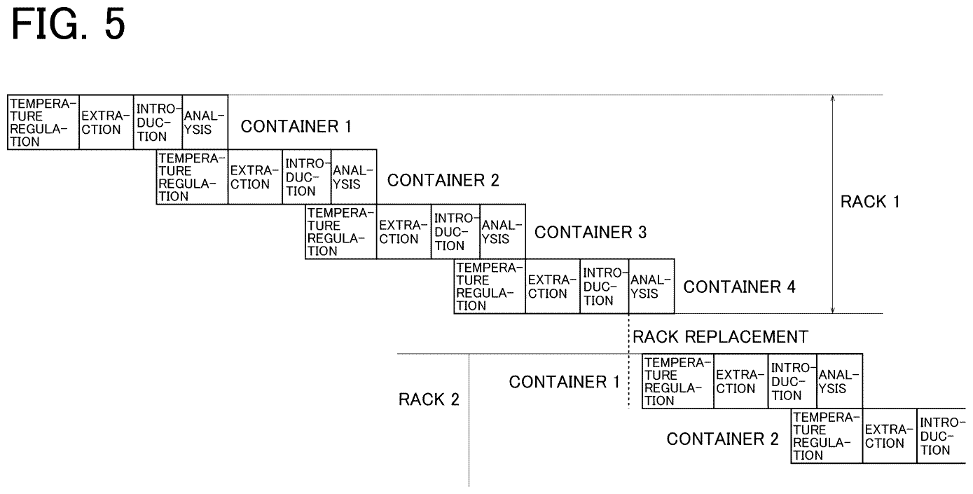

FIG. 5 is a timing chart for explaining an example of execution timing of a series of processing of samples in the plurality of extraction containers 10 held by the plurality of racks 8.

As shown in FIG. 5, temperature regulation, extraction of a component (extraction), introduction of the extracted component into the analysis channel 20 (introduction), and analysis are sequentially performed for the samples in the extraction containers 10 (containers 1 to 4) held in the same rack 8. In this example, the temperature regulation of the extraction container 10 of the next extraction target is started while processing such as extraction, introduction, and analysis for the sample of the extraction container 10 of the previous extraction target is executed, and the time required to complete the analysis of all the samples in the large number of extraction containers 10 held in the plurality of racks 8 is shortened as compared with the case where the temperature regulation of the extraction container 10 of the next extraction target is started after the analysis of the component extracted in the extraction container 10 of the previous extraction target is completed. Note that what timing the temperature regulation of the extraction container 10 of the next extraction target to start can be determined so as to be able to execute the extraction processing immediately when the extraction analysis device 2 is brought into a state of being executable of extraction processing of a component in the extraction container 10 of the next extraction target, in consideration of the time required for each of the temperature regulation, extraction, introduction, and analysis.

Furthermore, in the example of FIG. 5, replacement of the rack 8 is performed from a rack 1 to a rack 2 by the rack replacement device 4 immediately after the analysis of the component extracted in the extraction container 10 (the container 4 of the rack 1) of the last extraction target is started, and the temperature regulation of the extraction container 10 (the container 1) of the first extraction target of the new rack 8 (the rack 2) is started during the execution of the analysis. This enables the processing of a sample in the extraction container 10 of the previous extraction target and the processing of the sample in the extraction container 10 of the next extraction target to overlap each other even at the timing involving replacement of the rack 8, and can further shorten the time required to complete the analysis of the samples in the large number of extraction containers 10 held in the plurality of racks 8.

In general, a completion signal is output from the extraction analysis device when analysis of the samples in the extraction containers on the rack set in the extraction analysis device is all completed, but the rack replacement device cannot recognize the replacement timing of the rack until the completion signal is output from the extraction analysis device. On the other hand, in this example, since the extraction analysis device 2 outputs a replaceable signal at the timing when the rack 8 is brought into a replaceable state, the rack replacement device 4 can execute replacement of the rack 8 before the analysis of the samples in all the extraction containers 10 on the rack 8 set in the device is all completed, and overlapping of the processing at the timing involving replacement of the rack 8 is possible.

The example described above is merely an example of an embodiment of an extraction analysis system according to the present invention. An embodiment of an extraction analysis system according to the present invention is as follows.

One embodiment of an extraction analysis system according to the present invention is an extraction analysis system including an extraction analysis device and a rack replacement device. The extraction analysis device includes a placement table for placing a rack holding a plurality of extraction containers and an analysis channel for analyzing a component extracted from a sample. The extraction analysis device is configured to set the plurality of extraction containers held in the rack placed on the placement table as extraction targets in a preset order, to execute an extraction operation for extracting components from a sample to a mobile phase being a supercritical fluid in the extraction container set as the extraction target, and to execute analysis of the components by introducing extracted by the extraction operation into the analysis channel, the rack replacement device is configured to execute replacement of the rack on the placement table by performing movement of the rack from the placement table of the extraction analysis device and placement of the rack on the placement table, the extraction analysis device is configured to bring the rack into a movable state in which the rack can be moved from the placement table during the analysis of components extracted from a sample by the extraction operation in the extraction container set as a last extraction target among the plurality of extraction containers held in the rack, and the rack replacement device is configured to execute replacement of the rack on the placement table during the analysis of the component extracted by the extraction operation in the extraction container set as the last extraction target.

In aspect [1] of the one embodiment, the extraction analysis device includes, on the placement table, a heater for individually heating each of the extraction containers held on the rack, and is configured to execute a temperature regulation operation of regulating a temperature of the extraction container to a set temperature using the heater before executing the extraction operation in the extraction container set as the extraction target, and the extraction analysis device is configured to start the temperature regulation operation for the extraction container that is a first extraction target among the plurality of extraction containers held on the rack newly placed on the placement table after replacement of the rack on the placement table is executed by the rack replacement device and before analysis in the analysis channel is ended.

In aspect [2] described above of the one embodiment, the extraction analysis device outputs a rack replaceable signal immediately after the rack is brought into the movable state, and the rack replacement device is configured to execute replacement of the rack due to the rack replaceable signal output from the extraction analysis device.

This aspect [2] can be combined with aspect [1] described above.

In aspect [2] described above, a controller can be included, the controller is configured to control operations of the extraction analysis device and the rack replacement device using an operation sequence preset for the rack set in the rack replacement device. The controller can be configured to acquire, upon receiving the rack replaceable signal output from the extraction analysis device, rack information regarding the rack to be placed next onto the placement table from the operation sequence, and to notify the rack replacement device of the acquired rack information.

The controller can receive the rack replaceable signal from the extraction analysis device during the analysis of the component extracted by the extraction operation in the extraction container set as the last extraction target.

### DESCRIPTION OF REFERENCE SIGNS

1 Extraction analysis system
2 Extraction analysis device
4 Rack replacement device
6 Controller
8 Rack
10 Extraction container
12 Placement table
14 Mobile phase supply unit
16 Extraction valve
18 Vent valve
20 Analysis channel
22 Connection pipe
24 Heater
30, 32, 56 Pump
34 Mixer
36 Needle
38 Extraction channel
40 T-shaped pipe
42 Branch channel
46 Back pressure control valve (BPR)
48 Separation column
50 Detector
52 Home port
54 Cleaning port

What is claimed is:

1. An extraction analysis system comprising an extraction analysis device and a rack replacement device,
wherein
the extraction analysis device includes a placement table for placing a rack holding a plurality of extraction containers and an analysis channel for analyzing a component extracted from a sample, and the extraction analysis device is configured to set the plurality of extraction containers held in the rack placed on the placement table as extraction targets in a preset order, to execute an extraction operation for extracting components from a sample to a mobile phase being a supercritical fluid in the extraction container set as the extraction target, and to execute analysis of the components by introducing the components extracted by the extraction operation into the analysis channel,
the rack replacement device is configured to execute replacement of the rack on the placement table by performing movement of the rack from the placement table of the extraction analysis device and placement of the rack on the placement table,
the extraction analysis device is configured to bring the rack into a movable state in which the rack can be moved from the placement table during the analysis of components extracted from a sample by the extraction operation in the extraction container set as a last extraction target among the plurality of extraction containers held in the rack, and
the rack replacement device is configured to execute replacement of the rack on the placement table during the analysis of the components extracted by the extraction operation in the extraction container set as the last extraction target.

2. The extraction analysis system according to claim 1, wherein
the extraction analysis device includes, on the placement table, a heater for individually heating each of the extraction containers held on the rack, and is configured to execute a temperature regulation operation of regulating a temperature of the extraction container to a set temperature using the heater before executing the extraction operation in the extraction container set as the extraction target, and
the extraction analysis device is configured to start the temperature regulation operation for the extraction container that is a first extraction target among the plurality of extraction containers held on the rack newly placed on the placement table after replacement of the rack on the placement table is executed by the rack replacement device and before analysis in the analysis channel is ended.

3. The extraction analysis system according to claim 1, wherein
the extraction analysis device outputs a rack replaceable signal immediately after the rack is brought into the movable state, and
the rack replacement device is configured to execute replacement of the rack due to the rack replaceable signal output from the extraction analysis device.

4. The extraction analysis system according to claim 3, further comprising a controller configured to control operations of the extraction analysis device and the rack replacement device using an operation sequence preset for the rack set in the rack replacement device,
wherein the controller is configured to acquire, upon receiving the rack replaceable signal output from the extraction analysis device, rack information regarding the rack to be placed next onto the placement table from the operation sequence, and to notify the rack replacement device of the acquired rack information.

5. The extraction analysis system according to claim 4, wherein the controller is configured to receive the rack replaceable signal from the extraction analysis device during the analysis of the component extracted by the extraction operation in the extraction container set as the last extraction target.
